(19) United States
(12) Patent Application Publication
(10) Pub. No.: US 2002/0179396 A1
(43) Pub. Date: Dec. 5, 2002

(54) Thrust plate assembly

(75) Inventors: Hartmut Bach, Schweinfurt (DE); Cora Carlson, Dittelbrunn (DE); Matthias Dorfler, Schweinfurt (DE); Gunther Esly, Wasserlosen (DE); Reinhard Feldhaus, Niederwerrn (DE); Ingrid Hoffelner, Knetzgau (DE); Christoph Kleuker, Springe (DE); Paul Kraus, Niederwerrn (DE); Andreas Orlamunder, Schweinfurt (DE); Bernd Peinemann, Niederwerrn (DE); Michael Peterseim, Oberdorla (DE); Gerhard Roll, Eisenheim (DE); Ralf Till, Euerbach (DE); Sebastian Vogt, Bad Neustadt (DE); Andreas Dau, Wurzburg (DE)

Correspondence Address: Thomas C. Pontani, Esq., Cohen, Pontani, Lieberman & Pavane, Suite 1210, 551 Fifth Avenue, New York, NY, 10176, US

(73) Assignee: ZF Sachs AG

(21) Appl. No.: 10/160,338

(22) Filed: May 30, 2002

(30) Foreign Application Priority Data
Jun. 1, 2001 (DE) 101 26 778.9

(51) Int. Cl. F16D 13/71

(52) U.S. Cl. 192/70.18

(57) ABSTRACT

A housing arrangement is coupled to a pressure plate arrangement by at least a first coupling arrangement so as to be relatively movable in direction of an axis of rotation (A). The first coupling arrangement comprises at least one coupling element which is secured at least in a first coupling area to a coupling portion of the pressure plate arrangement and is secured in a second coupling area to a coupling portion of the housing arrangement. The at least one coupling element of the at least first coupling arrangement comprises fiber material.

### BACKGROUND OF THE INVENTION

1. Field of the Invention

The present invention is directed to a thrust plate assembly comprising a housing arrangement and a pressure plate arrangement which is coupled by at least a first coupling arrangement to the housing arrangement so as to be movable with respect to the latter in direction of an axis of rotation. At least the first coupling arrangement comprises at least one coupling element which is secured in a first coupling area to a coupling portion of the pressure plate arrangement and is secured in a second coupling area to a coupling portion of the housing arrangement.

2. Description of the Related Art

Connecting a pressure plate to a housing arrangement by means of tangential leaf springs is a variant that has long been known in the area of friction clutches by which a pressure plate can be connected with the housing arrangement so as to be essentially fixed with respect to rotation and displaceable axially relative to this housing arrangement. In known friction clutches, the tangential leaf springs extend in circumferential direction from the respective connection areas of the pressure plate to an associated connection area of the housing arrangement. Since all tangential leaf springs are identically oriented in circumferential direction, a configuration results such that in pull operation, for example, the tangential leaf springs are also tensile loaded, while in push operation, that is, for example, when there is an engine braking effect, the tangential leaf springs are compression loaded. While this compression loading is not a problem in conventional arrangements in which these tangential leaf springs are constructed essentially flat, i.e., without curvature, problems result in arrangements which are constructed for generating a self-energizing or self-reinforcing pressing effect. In these thrust plate assemblies with self-reinforcing pressing effect, the tangential leaf springs are sharply curved in axial direction between the two arrangement areas at the pressure plate on the one hand and at the housing arrangement on the other hand. In pull operation, these tangential leaf springs which are then also tensile loaded tend to stretch, as a result of which, due to the axial offset of the two arrangement areas, the pressure plate is pressed with greater force against the friction linings of a clutch disk. However, in push operation, these sharply curved structural component parts can very easily be deformed and compressed which can even result in breakage of the same.

### SUMMARY OF THE INVENTION

It is the object of the present invention to further develop a thrust plate assembly of the type mentioned above in such a way the coupling elements used for the transmission of torque between the housing arrangement and the pressure plate arrangement in the pull state are not damaged in the push state.

According to a first aspect, this object is met in a thrust plate assembly of the type mentioned above in that the at least one coupling element of the at least first coupling arrangement comprises fiber material.

Through the use of fibers or fiber material, coupling elements are provided which are capable of very high tensile or stretch loading, but which are otherwise very flexible and, due to their high flexibility which essentially does not take place under pretensioning, can not be damaged by compression loading.

In order to provide an arrangement which is as stable as possible, it is proposed that the fibers of the fiber material cooperate in the manner of a weave, knit, braid or the like for transmitting force.

The fibers of the fiber material can be, for example, sisal, ramie, carbon-containing material, preferably silicon carbide, glass material, ceramic material, aramide, polyamide or metal material, preferably tungsten or aluminum.

Further, a very stable arrangement can be achieved in that the fibers of the fiber material are embedded in a matrix material at least in some areas to form a fiber composite. In this case, the matrix material can comprise metal material, preferably steel material or bronze material, carbon-containing material, duroplastic material, ceramic material or glass material.

According to another aspect, the above-stated object is met in a thrust plate assembly of the type mentioned above in that the at least one coupling element is formed of foil material.

Through the use of a foil material, that is, a material having a thickness in the range of only 1 μm-100 μm, for example, coupling elements are produced which can be stretch loaded to a very high degree but which, because of their very great flexibility, can yield when loaded in the opposite direction so that the risk of damage is eliminated.

In this connection, for example, the foil material can comprise metal foil material, preferably steel material. Further, it is possible that the foil material comprises plastic foil material, preferably polymer material. In order to increase the torque transmission capacity or to adapt it to existing requirements, the at least first coupling arrangement can comprise a plurality of coupling elements. Of course, the different coupling elements can then be formed of different materials and can also have different thicknesses.

According to another aspect, the above-stated object is met in a thrust plate assembly according to the invention in that the at least one coupling element has a plurality of successive coupling element members in longitudinal direction of the coupling element.

By providing a plurality of coupling element members, a chain-like configuration is created which, on the one hand, can be very highly loaded for torque transmission but which, on the other hand, can yield very easily when loaded in the opposite direction because of its high flexibility and is therefore also not exposed to the risk of damage.

In order to be able to connect the coupling elements to the pressure plate arrangement as well as the housing arrangement in a stable manner without the risk of damaging these coupling elements themselves, it is suggested that a fastening element is provided in at least one of the coupling areas at the at least one coupling element, which fastening element engages around this coupling element at least in some areas. For example, it is possible that the fastening element is held at the coupling element by clamping action, welding, casting or the like.

The coupling elements of the at least first coupling arrangement which are used in the thrust plate assembly according to the invention are characterized generally in that they can absorb very high stretch loading, but otherwise have very high flexibility without generating any substantial restoring forces or dimensional stability forces. However, in order to be able to achieve a torque transmission coupling between the housing arrangement and the pressure plate arrangement also in the push state, at least a second coupling arrangement can be provided by which the pressure plate arrangement is coupled with the housing arrangement for torque transmission in a direction opposite to a torque transmission direction in which the torque can be transmitted via the at least first coupling arrangement. For example, it is possible that the at least one second coupling arrangement comprises at least one coupling element of elastic material, preferably rubber-like material.

Since, as was already mentioned, the coupling elements of the first coupling element arrangement according to the invention have no dimensional stability characteristics in the sense of generating possible restoring forces or the like due to their high flexibility, it is suggested according to another aspect of the present invention that the thrust plate assembly has a lifting force generating arrangement. For example, this can comprise at least one leaf spring element which is secured to an assembly comprising the pressure plate arrangement and housing arrangement and which is supported in axial direction at the other assembly comprising the pressure plate arrangement and housing arrangement.

The present invention is further directed to a friction clutch comprising a thrust plate assembly according to the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial longitudinal section through a friction clutch;

FIG. 2 is a schematic axial view of the pressure plate of the friction clutch shown in FIG. 1, which pressure plate is coupled with a housing arrangement;

FIG. 3 shows the principle of operation of a clutch with self-reinforcing action;

FIG. 4 shows a top view of a coupling element;

FIG. 5 is a view corresponding to FIG. 4 showing the coupling element with fastening elements;

FIG. 6 is a view corresponding to FIG. 4 showing the coupling element with fastening elements;

FIG. 7 shows a top view of a coupling element from FIG. 4 in the fastened state;

FIG. 8 shows a sectional view through the coupling element shown in FIG. 7 along a section line VIII-VIII;

FIG. 9 is a view corresponding to FIG. 8 showing an alternative type of fastening of a coupling element;

FIG. 10 is another view corresponding to FIG. 8 showing an alternative type of fastening of a coupling element;

FIG. 11 shows a sectional view along a section line XI-XI in FIG. 10;

FIG. 12 shows a partial sectional view of a thrust plate assembly according to the invention from the radial outside;

FIG. 13 shows a top view of a lifting spring;

FIG. 14 shows a side view of a rivet stud cooperating with a lifting spring;

FIG. 15 shows an alternative type of rivet stud cooperating with a lifting spring;

FIG. 16 is a view corresponding to FIG. 12 showing an alternative embodiment form;

FIG. 17 shows a schematic partial sectional view of a thrust plate assembly according to the invention, considered from the radial outer side; and

FIG. 18 is a view corresponding to FIG. 17 showing an alternative embodiment form.

### DETAILED DESCRIPTION OF THE PRESENTLY PREFERRED EMBODIMENTS

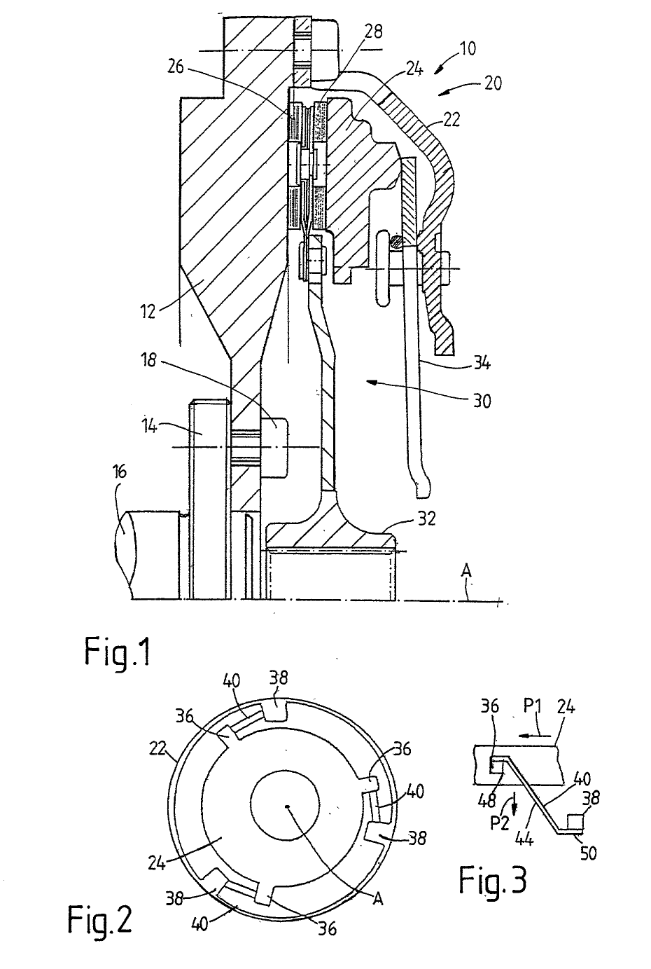

The basic construction of a friction clutch 10 in which the inventive principles are or can be realized is shown in FIGS. 1 and 2. The friction clutch 10 comprises a flywheel 12 which can be constructed, for example, as a dual-mass flywheel, which is secured in the radial inner area to a crankshaft flange 14 of a crankshaft 16 or some other drive shaft by a plurality of screw bolts 18. In its radial outer area, the flywheel 12 is fixedly connected with a thrust plate assembly 20. The thrust plate assembly 20 comprises a housing 22 and a pressure plate 24 which is axially displaceable in the housing 22 but is held so as to be substantially fixed with respect to rotation relative to the housing 22. The friction facings 26, 28 of a clutch disk 30 are located between the pressure plate 24 and the flywheel 12. This clutch disk 30 can be coupled in its radial inner hub area 32 with a driven shaft, for example, a transmission input shaft, so as to be fixed with respect to rotation relative to it. The pressure plate 24 is pretensioned basically in the direction of the flywheel 12 by an energy accumulator 34, for example, a diaphragm spring. In the present example, the clutch 10 is a push-type clutch.

As is shown in FIG. 2, coupling portions 36 and 38, respectively, as provided at the pressure plate 24 and at the housing arrangement 22 or, as the case may be, also at the flywheel 12. One of the coupling portions 36 and one of the coupling portions 38 are connected with one another by a coupling arrangement 40 extending approximately in circumferential direction. These coupling arrangements 40 are formed of flexible elements so that, in principle, an axial movement of the pressure plate 24 is possible for carrying out engagement and release processes. When the coupling portions 36, 38 are offset relative to one another in direction of the axis of rotation as is illustrated in FIG. 3 and the coupling arrangements 40 extend in the manner shown in FIG. 3, an application of force of the pressure plate 24 in circumferential direction with respect to the housing arrangement 22 in the direction indicated by the arrow P₁, which occurs, for example, in pull operation, results in a deflection of force due to lever ratios and leads to a reinforcement of the pressing force exerted on the friction facings 28, 26 by the pressing force 24, which reinforcement is directed as indicated by arrow P₂. In this type of clutch 10 with a self-reinforcing effect, it is possible to achieve pressing forces which are fundamentally higher than those that can be attained by conventional diaphragm springs while still allowing actuation. If an extremely high pressing force is not required, it is possible to provide the diaphragm spring and the energy accumulator 34 with lower pressing force capacity so that smaller release forces are also required.

It should be noted that only the basic construction of a friction clutch with self-reinforcing effect has been described thus far. Of course, a wide range of changes can be implemented in a clutch of this kind whether or not the principles of the present invention are applied, e.g., providing a wear compensating arrangement, a multi-mass flywheel as was already mentioned, a torsional vibration damper in the area of the clutch disk, and so on.

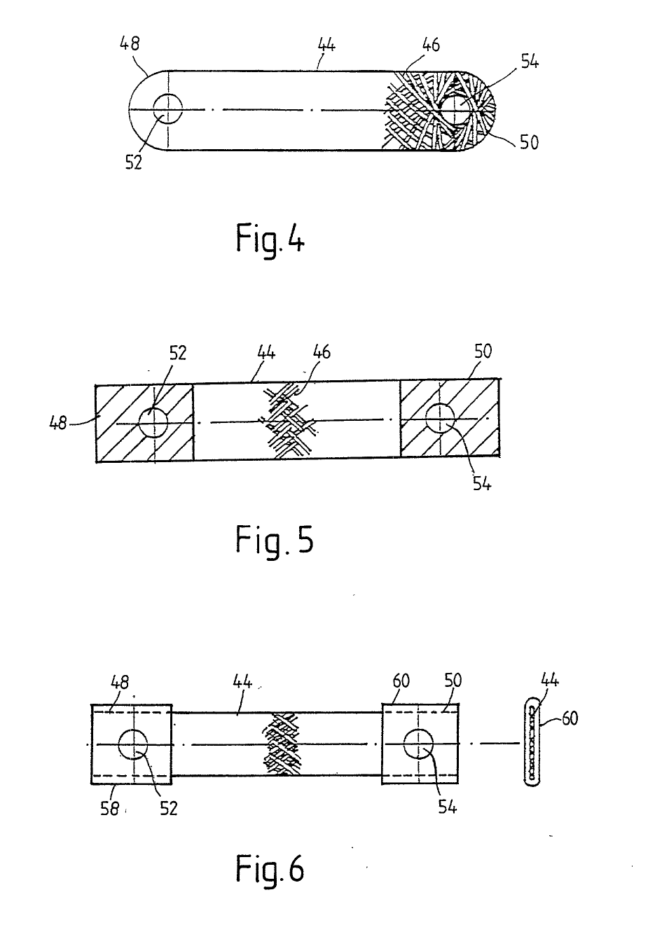

A coupling element 44 which is usable in the thrust plate assembly 20 according to the invention is shown in a top view in FIG. 4. This coupling element 44 is formed of a plurality of individual fibers or fiber portions. The fibers can be connected with one another in the manner of a knit, braid or weave in order to achieve a stable belt-like or band-like structure. Natural materials such as sisal or ramie, for example, or organic materials such as aramide, carbon-containing materials or polyamide can be used as fiber materials. Inorganic materials such as glass, silicon carbide and ceramic or metallic materials such as steel, tungsten or aluminum wires can also be used. By providing coupling elements 44 of this kind which then, as coupling arrangements 40, provide the torque transmission between the pressure plate 24 and the housing 22, very flexible elements are used which, on the one hand, can be very highly stretch loaded in pull operation but which, on the other hand, can yield easily when changing to push operation due to their high flexibility and are therefore not exposed to the risk of damage under compression.

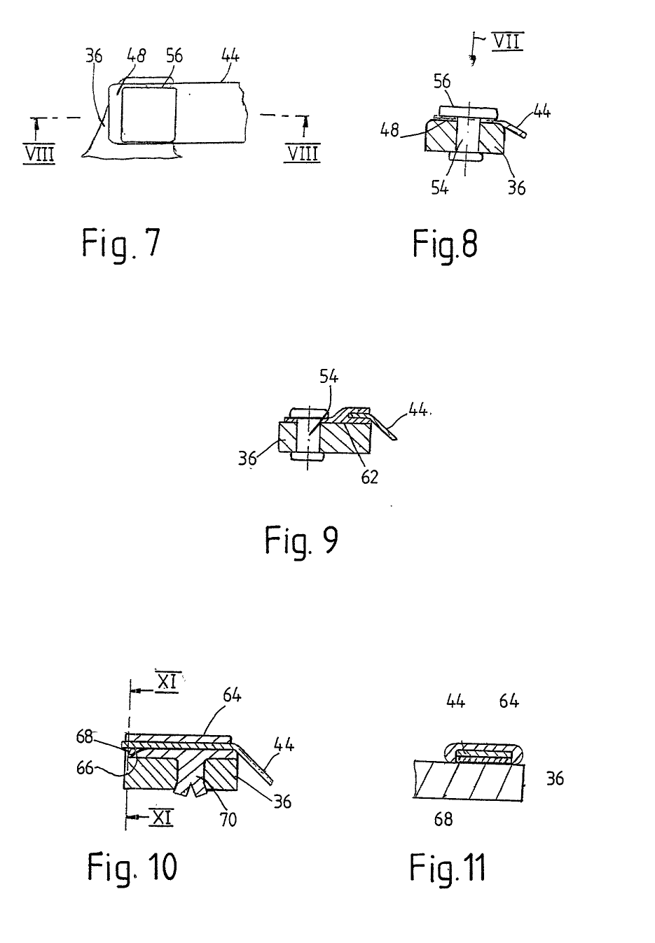

In order to achieve a stable connection to the respective coupling portions 36 and 38 of the pressure plate 24 and housing 22, respectively, in the two coupling areas 48, 50, it can be provided, for example, that the coupling elements 24 are produced in such a way already during the manufacturing process that openings 52, 54 are provided. It is possible, for example, to work the individual fibers or fiber portions 46 around rivet studs by which the coupling elements 44 are then secured to the pressure plate 24 and housing 22. In this case, the openings must not be produced by punching or drilling which would break the fiber structure. FIGS. 7 and 8 show the connection of a coupling element 44 of the type mentioned above which is formed of fibers, for example, at a radial outward projecting coupling portion 36 of the pressure plate 24 by means of a rivet stud 54. The top view in FIG. 7 shows that the rivet stud 54 has a right-angled shape in the area of its head 56, so that an elongated edge extends transversely over the coupling element 44 and point loading is accordingly avoided.

The coupling element 44 shown in FIG. 5 is constructed in such a way that a composite material structure is obtained in both coupling areas 48, 50. In this case, for example, the material of the fibers 46 can be embedded in a matrix material such as copper or aluminum, so that a very strong structural cohesiveness is achieved in these coupling areas. The openings 52, 54 can then be introduced in these areas also by means of punching or drilling without the risk of damaging the overall structure. There is no risk of fraying due to breakage of the structure of the individual fibers or fiber portions 46. In this regard, it should be noted that, of course, materials other than those indicated above can be used to form the composite structure; for example, plastic materials or other metals such as tin, steel, bronze, or ceramic materials can also be used.

In the embodiment form according to FIG. 6, the coupling element 44 is inserted by its two coupling areas 48, 50 in respective fastening elements 58, 60 constructed as hollow sections and are secured in the latter, for example, by squeezing. These fastening elements 58, 60 preferably comprise an easily deformable material such as aluminum or copper and likewise ensure that there is no risk of fraying in openings 52, 54 formed by drilling or stamping.

Another alternative embodiment form for fastening coupling elements 44 which are constructed from fiber material in this way is shown in FIG. 9. It can be seen that a fastening element 62 is secured by a rivet stud 54 to the coupling portion 36 of the pressure plate 24, for example, and engages in the manner of pliers around the end area of the fiber material and is secured to the latter, for example, by pressing.

The fastening element 64 shown in FIG. 10 and FIG. 11 again has an approximately hollow section structure which encloses the end area of the fiber material and is secured to the latter by pressing. In addition, the fastening element 64 has an inclined surface or ramp surface 66 at its end toward the end area of the fiber material, and a wedge element 68 which is also supported at the fiber material of the coupling element 44 in addition contacts this inclined surface or ramp surface 66. When force is applied, the fiber material shown in FIG. 10 is acted upon or displaced with respect to the fastening element 64 in such a way that the wedge element 68 is pulled by the existing friction forces into the tapering intermediate space between the fiber material and the surface 66 in a strengthened manner and accordingly provides additionally for locking. Further, it will be seen that a rivet portion 70 is provided integral with the fastening element 64, which rivet portion 70 penetrates a corresponding opening in the coupling portion 36 and, of course, as the case may be, in the coupling portion 38, and is secured at the latter by pressing or spreading.

As has already been mentioned, many different materials may be used in the coupling elements 44 according to the invention which are formed of fiber materials. Further, many different manufacturing techniques can be used to produce such elements. Of course, when manufactured in a corresponding manner, a coupling of this kind can be formed of an individual continuous filament which is moved in a corresponding manner during manufacture and which then extends between the two coupling areas 48, 50 with a plurality of fibers 46 which pass into one another so as to be integral, as can be seen in FIG. 4, for example. By a construction of this kind is also meant, within the meaning of the present invention, a construction formed of a plurality of fibers or fiber portions extending in the area between the individual coupling portions 48, 50.

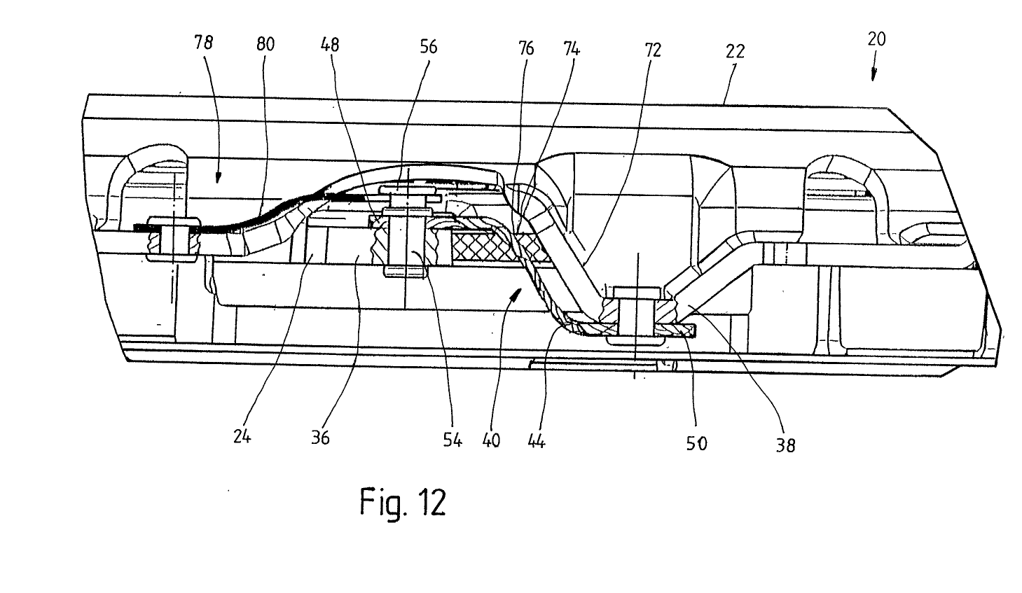

FIG. 12 shows another type of construction of a thrust plate assembly according to the invention. FIG. 12 again shows the coupling element 40 which is formed of a plurality of fibers or fiber portions, for example, and which is secured by both its coupling areas 48, 50 to a coupling portion 36 of the pressure plate and a coupling portion 38 of the housing 22, respectively. As was already mentioned, this coupling portion 38 is preferably provided at an area 72 of the housing 22 which projects radially outward in the manner of a flange or rim. Due to the fact that flexible coupling elements 44 of this kind can transmit substantially only forces exerting a tensile or elongation load upon them, as was mentioned above, a supporting element 74 is allocated to at least one, but preferably all, coupling elements 44. This supporting element 74 is arranged in such a way that it is substantially disposed between a radially outward projecting coupling portion 36 of the pressure plate 24 and the rim-like area 72 of the housing 22 in an area between coupling portions 36, 38 which face one another. In push operation, the coupling portion 36 in the thrust plate assembly 20 shown in FIG. 12 is moved to the right toward the coupling portion 38 so that the supporting element 74 provides for a torque transmission while bridging the coupling element 44 shown in the drawing. In this case, it can also be provided, for example, that an opening is provided in the supporting element 74, which opening penetrates the coupling element 44 so as to ensure that the supporting element 74 is also held in this way at the same time.

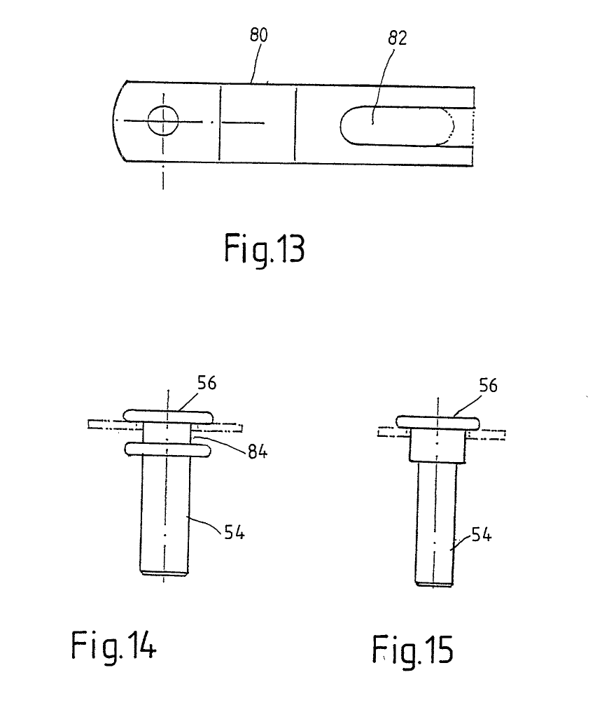

Further, because of the flexibility of the coupling elements 44, they are not capable of generating pretensioning forces acting upon the pressure plate 24 in one direction or the other. Accordingly, a separate arrangement 78 must be provided particularly for generating the lifting force. In the example shown in the drawing, this arrangement 78 comprises a plurality of leaf spring elements 80 which are arranged so as to be distributed in circumferential direction. These leaf spring elements 80 are riveted in one of their end areas to the rim-like area 72 of the housing 22 and, in their other end area, engage at the pressure plate 24 or at a component fixedly coupled to the latter. It will be seen in particular that this leaf spring element 80 engages by a fork-like end area 82 shown in FIG. 13 in a radial recess 84 of the spool-shaped rivet stud head 56. Accordingly, due to the shape and pretensioning effect of the leaf spring element 80, a pretensioning of the pressure plate 24 in the direction axially away from the flywheel is permanently ensured, while the pressure plate is nevertheless substantially freely movable in circumferential direction with respect to the leaf spring element 80 or with respect to each leaf spring element 80.

The head 56 of the rivet stud 54 can also be constructed with a single stepped contour as is shown in FIG. 15. In this case, the end of the leaf spring element 80 which opens in a fork-like manner and is indicated in a dash-dot line in FIG. 13 can be constructed in a closed manner.

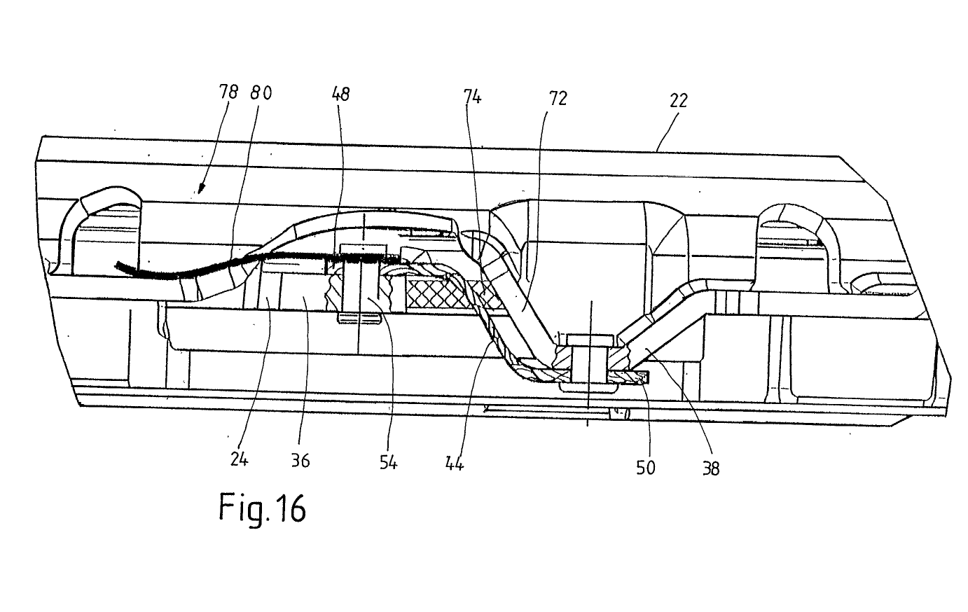

FIG. 16 shows a modification of the embodiment form shown in FIG. 12. It will be seen that the coupling area 48 of the coupling element 44 is fastened to the coupling portion 36 of the pressure plate 24 and a leaf spring element 80 of the lifting force generating arrangement 78 is also secured to the pressure plate 24 by means of the rivet stud 54 in both instances. The leaf spring element 80 is supported in its other end area at the side of the radial outward projecting rim area 72 remote of the flywheel. In this case also, a substantially unimpeded circumferential movability of the leaf spring element 80 is ensured in one of its end areas.

By means of suitable shaping, selection of material and, as the case may be, by providing different opening areas in a leaf spring element 80 of this kind, the lifting force which can be provided in this way can be adapted to the given requirements in a simple manner.

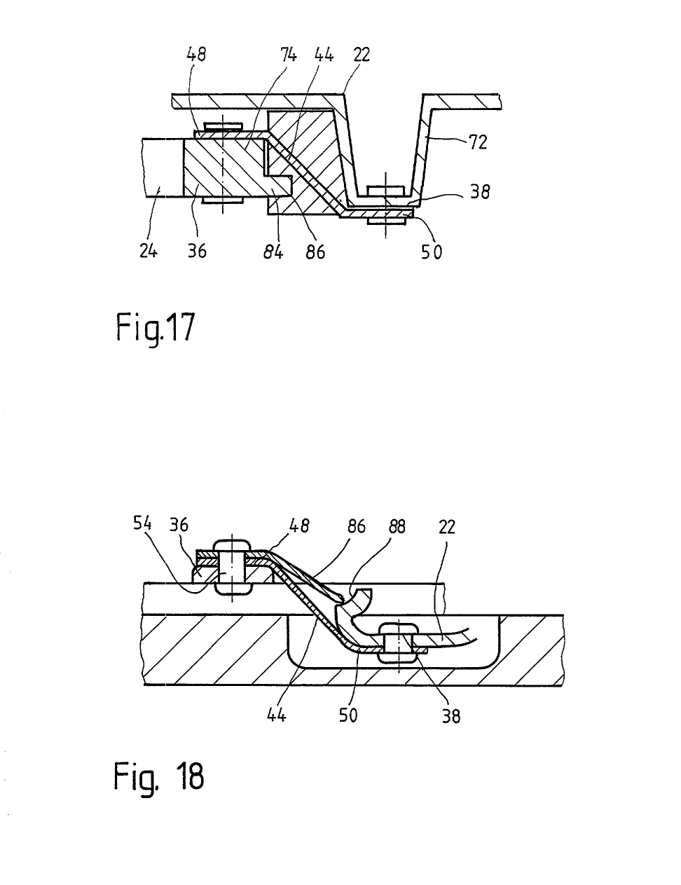

FIG. 17 shows another embodiment form in which a torque transmission between the housing 22 and the pressure plate 24 can be achieved in pull operation by means of a flexible coupling element 44 or a plurality of such coupling elements 44 distributed in circumferential direction or, as the case may be, also by coupling elements 44 which are grouped together in pairs. In push operation, a block 74 of elastomeric material takes over this function of torque transmission between the housing 22 and the pressure plate 24. It will also be seen in this case that the coupling element 44 penetrates the block 74 and, for example, can also be cast integral therein, particularly in order to hold this block 74 against the action of centrifugal force. Further, the coupling portion 36 of pressure plate 24 engages in a corresponding cutout 86 of the block 74 by a circumferential projection 84. In this way, a lifting force which pretensions the pressure plate in axial direction is additionally ensured, for example, when the block 74 is also secured to the housing 22 in its other end area. Of course, the leaf springs mentioned above can also be provided.

In the embodiment form shown in FIG. 18, a leaf spring element 86 is also secured to the coupling portion 36 of the pressure plate 24 by means of the rivet stud 54 by the coupling area 48 of the coupling element 44. The leaf spring element 86 extends in circumferential direction along the coupling element 44 and contacts an abutment area 88 of the housing 22 by its free end area. The abutment area 88 can have a concave contour. The leaf spring element 86 is supported at this abutment area 88 in axial direction as well as in circumferential direction, so that this leaf spring element 86 serves as torque support in push operation on the one hand and for lifting force generation on the other hand. In particular, it will be seen that in push operation, that is, in a state in which in FIG. 18 the coupling portion 36 is acted upon toward the right with respect to the housing 22, the leaf spring element 86 provides for generation of a lift-off force due to its rigidity. Accordingly, torque peaks can be contained by the pressing force which is then reduced in push operation by allowing a determined slip in the coupling.

The coupling elements according to the invention which are formed of fiber material can be used in all of the embodiment forms described above. These coupling elements have the substantial advantage that, due to their flexibility, they are not subject to the risk of damage caused by compression. It should be noted that other configurations of coupling elements having the same advantage can also be used. For example, coupling elements formed by a plurality of coupling element members can be used. These coupling elements which are constructed in the manner of a chain can also be stretch loaded to a very high degree, but are otherwise very flexible. Further, it is possible to use foil-like, i.e., very thin, material for the coupling elements which likewise offers the advantage of high flexibility. Plastic foil materials, e.g., polymers, or metal materials such as steel and other stable metals can be used in this case, for example. It is also possible to form the individual coupling arrangements 40 from a plurality of layers of such material foils. Regardless of which type of configuration of coupling elements mentioned above is used, the above-mentioned possibilities for connecting these coupling elements to the pressure plate on the one hand and to the housing on the other hand can be used with the above-mentioned advantages. The different fastening elements and fastening methods described above can be used regardless of the type of coupling elements that are used.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A thrust plate assembly comprising
a housing having at least one coupling portion,
a pressure plate having a at least one coupling portion, and
a first coupling arrangement coupling said pressure plate to said housing so that said pressure plate is movable relative to said housing in the direction of an axis of rotation, said first coupling arrangement comprising at least one first coupling element having a first coupling area secured to the coupling portion of the pressure plate, and a second coupling area secured to the coupling portion of the housing, said at least one first coupling element comprising one of a fiber material containing fibers and a foil material.

2. A thrust plate assembly as in claim 1 wherein said at least one first coupling element comprises a fiber material containing fibers.

3. A thrust plate assembly as in claim 2 wherein said fibers are at least one of knit, woven or braided.

4. A thrust plate assembly as in claim 2 wherein said fibers comprise at least one of sisal, ramie, carbon-containing material, glass material, ceramic material, aramide, polyamide, and metal.

5. A thrust plate assembly as in claim 2 wherein said at least one coupling element comprises a fiber composite comprising a matrix material in which said fibers are embedded.

6. A thrust plate assembly as in claim 5 wherein the matrix material comprises one of metal, carbon-containing material, duroplastic material, ceramic material, and glass material.

7. A thrust plate assembly as in claim 1 wherein said at least one first coupling element comprises a foil material.

8. A thrust plate assembly as in claim 7 wherein said foil material has a thickness in the range of 1 μm-100 μm.

9. A thrust plate assembly as in claim 7 wherein said foil material is steel.

10. A thrust plate assembly as in claim 7 wherein said foil material is a polymer.

11. A thrust plate assembly as in claim 7 wherein said first coupling arrangement comprises a plurality of said first coupling elements.

12. A thrust plate assembly as in claim 1 wherein
said housing comprises a plurality of coupling portions,
said pressure plate comprises a plurality of coupling portions, and
said first coupling arrangement comprises a plurality of said first coupling elements arranged successively in the circumferential direction, each said first coupling element having a first coupling area secured to a respective said coupling portion of the pressure plate, and a second coupling area secured to a respective said coupling portion of the housing.

13. A thrust plate assembly as in claim 1 wherein each said first coupling element comprises a fastening element which engages around at least one of said first and second coupling areas.

14. A thrust plate assembly as in claim 13 wherein each said fastening element is fixed to said first coupling element by one of clamping, welding, and casting.

15. A thrust plate assembly as in claim 1 further comprising a second coupling arrangement coupling said pressure plate to said housing for torque transmission in a direction opposite to a torque transmission direction in which torque can be transmitted via the first coupling arrangement, said second coupling arrangement comprising at least one second coupling element secured to the pressure plate and the housing.

16. A thrust plate assembly as in claim 15 wherein said second coupling arrangement comprises at least one block of elastomeric material in which a respective said at least one second coupling element is embedded.

17. A thrust plate assembly as in claim 1 further comprising a lifting force generating arrangement for generating a lifting force for lifting said pressure plate relative to said housing.

18. A thrust plate assembly as in claim 17 wherein said lifting force generating arrangement comprises at least one leaf spring element which is secured to one of said pressure plate and said housing and supported axially against the other of said pressure plate and said housing.

19. A friction clutch comprising a thrust plate assembly, said thrust plate assembly comprising
a housing having at least one coupling portion,
a pressure plate having a at least one coupling portion, and
a first coupling arrangement coupling said pressure plate to said housing so that said pressure plate is movable relative to said housing in the direction of an axis of rotation, said first coupling arrangement comprising at least one first coupling element having a first coupling area secured to the coupling portion of the pressure plate, and a second coupling area secured to the coupling portion of the housing, said at least one first coupling element comprising one of a fiber material containing fibers and a foil material.
